(19) United States
(12) Patent Application Publication
(10) Pub. No.: US 2024/0386358 A1
(43) Pub. Date: Nov. 21, 2024

(54) INSIGHT DISCOVERY USING COMBINATORIAL LOW-DIMENSIONAL CLUSTERING

(71) Applicant: INTERNATIONAL BUSINESS MACHINES CORPORATION, ARMONK, NY (US)

(72) Inventors: Pedro Miguel Barbas, Dunboyne (IE); Clara Liu, Markham (CA); DEEPAK KULKARNI, Hyderabad (IN); Navneet Dalipkum Magotra, Cary, NC (US); Christian Cesar Bones, Sao Carlos (BR)

(21) Appl. No.: 18/320,291

(22) Filed: May 19, 2023

(51) Int. Cl. G06Q 10/0639

(52) U.S. Cl. CPC G06Q 10/06393

(57) ABSTRACT

An embodiment for improved insight discovery using combinatorial low-dimensional clustering. The embodiment may detect a set of data point key performance indicators (KPIs) from one or more statistical or machine learning domain spaces. The embodiment may generate clusters including a series of binary vectors corresponding to the detected set of data point KPIs, wherein neighboring binary vectors having a mutual Mahalanobis distance below a threshold value are clustered together. The embodiment may generate weighted binary matrix representations of the generated clusters The embodiment may perform insight discovery by identifying data point intersections within the generated weighted binary matrix representations.

### BACKGROUND

The present application relates generally to computer processing, and more particularly, to improved insight discovery using combinatorial low-dimensional clustering.

An increasing number of businesses utilize software solutions in the form of Enterprise Performance Management (EPM) systems to help manage an organization's performance and make better-informed decisions through insight discovery. For example, an EPM may help an organization process data to identify areas for improvement, track progress against key performance indicators (KPIs), and make informed decisions about resource allocation, investments, or other strategic initiatives. As EPM systems are tasked with integrating increasingly vast amounts data that may be derived from multiple statistic or machine learning domains, correlation analysis tools are relied upon to identify relationships between variables (or KPIs) that may then be leveraged to perform insight discovery. The effectiveness of these correlation tools may directly impact the value and insights provided by a given EPM system.

### SUMMARY

According to one embodiment, a method, computer system, and computer program product for improved insight discovery using combinatorial low-dimensional clustering is provided. The embodiment may include detecting a set of data point key performance indicators (KPIs) from one or more statistical or machine learning domain spaces. The embodiment may also include generating clusters including a series of binary vectors corresponding to the detected set of data point KPIs, wherein neighboring binary vectors having a mutual Mahalanobis distance below a threshold value are clustered together. The embodiment may further include generating weighted binary matrix representations of the generated clusters. The embodiment may also include performing insight discovery by identifying data point intersections within the generated weighted binary matrix representations.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process for improved insight discovery using combinatorial low-dimensional clustering according to at least one embodiment;

FIG. 3 illustrates an exemplary clustering scheme in accordance with an exemplary process for improved insight discovery using combinatorial low-dimensional clustering according to at least one embodiment;

FIG. 4 illustrates an exemplary weighted binary matrix representation of a clustering scheme including 20 binary vectors that may be generated in accordance with an exemplary process for improved insight discovery using combinatorial low-dimensional clustering according to at least one embodiment; and

FIG. 5 depicts two exemplary clustering windows and an associated illustrative histogram that may be generated by presently described embodiments by scanning the two exemplary clustering windows during an illustrative process for improved insight discovery using combinatorial low-dimensional clustering according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to computer processing, and more particularly, to improved insight discovery using combinatorial low-dimensional clustering. The following described exemplary embodiments provide a system, method, and program product to, among other things, detect a set of data point key performance indicators (KPIs) from one or more statistical or machine learning domain spaces, generate clusters including a series of binary vectors corresponding to the detected set of data point KPIs, wherein neighboring binary vectors having a mutual Mahalanobis distance below a threshold value are clustered together, generate weighted binary matrix representations of the generated clusters; and perform insight discovery by identifying data point intersections within the generated weighted binary matrix representations. Therefore, the presently described embodiments have the capacity to improve insight discovery using combinatorial low-dimensional clustering by leveraging combinatorial cluster strategies in which clusters, rather than individual binary vectors, are assigned binary matrix representations. Thus, the identify of each data point KPI in presently described embodiments is ciphered within the clustering pattern rather than by its association with a particular binary vector sequence. Deciphering the pattern allows the trajectory of an original data point KPI to be inferred with high confidence. Consequently, this learning results in significant reduction in KPI insight discovery time (down to the scale of hours rather than weeks when compared to conventional correlation analysis tools) for new data points. Furthermore, neighboring binary vectors of multiple statistical or machine learning domain spaces that also share the same initial search space are likely to exhibit similar data point trajectories. Hence, the similarity measure of clustering algorithm utilized by presently described embodiments may be based on the Mahalanobis distance of binary vectors and the initial search space of the binary vectors.

As previously described, an increasing number of businesses utilize software solutions in the form of Enterprise Performance Management (EPM) systems to help manage the organization's performance and make better-informed decisions through insight discovery. For example, an EPM may help an organization process data to identify areas for improvement, track progress against key performance indicators (KPIs), and make informed decisions about resource allocation, investments, or other strategic initiatives. As EPM systems are tasked with integrating increasingly vast amounts data that may be derived from multiple statistic or machine learning domains, correlation analysis tools are relied upon to identify relationships between variables (or KPIs) that may then be leveraged to perform insight discovery. The effectiveness of these correlation tools may directly impact the value and insights provided by a given EPM system.

However, there are many challenges experienced by EPMs that rely upon conventional correlation tools. For example, when using conventional correlation tools, correlations become difficult to interpret, manage, and survey once the number of variables becomes even moderately large. The problem becomes more complex when multiple statistical or machine learning domains are present. Exemplary statistical or machine learning domains may include, for example, random graphs, random trees, causal trees, Markov chains, analysis of variance, and inferences, among many others. Consequently, as vast amounts of complex data from multiple domains becomes increasingly common, utilizing correlation tools to perform Insights as a Service Discovery (IaaSD) becomes a highly complex combinatorial multiobjective optimization problem.

Conventional correlation analysis tools thus become significantly less effective for discovery of complex insights by using multiple business domains and multiple machine learning or artificial intelligence (AI) perspectives. For example, assuming a denormalized table including an exemplary ‘Company X’ data related to finance and sales (including only two business domains for simplification), a user may want to utilize conventional correlation tools to understand a correlation analysis, which involves running an algorithm that compares each pair of columns (KPI's) and loops in different permutation until the end of the table is reached. If the user is considering data only for a single year this may take more than one week to uncover all interesting correlation combinations insights (KPI pairs). Next, only after performing this first step, the user may then want to perform looking at all the combinations from the previous set, but when applied to multiple areas. For example, by considering a previous correlation insight between an exemplary KPI ‘X’ related to ‘Sales deals won during the current year’ and a second exemplary KPI ‘Y’ related to ‘Budget available during current year’ the user may want to understand if this KPI pair insight is dependent of another datapoint such as ‘Country’, ‘Market’, or ‘GEO’, etc. Consequently, this would involve the correlation tool utilizing another algorithm containing all the combinations and permutations of these 2 or 3 KPI's to execute analysis of variance (ANOVA) techniques using those combinations. This step may also take, for example, up to one week to execute. Next, only after performing this step, the user may want to additionally perform inference analysis to be sure that previous insights do not happen by accident. This step may also take weeks depending upon the data being considered. Additional steps would involve investing an even greater amount of time. This example illustrates that as vast amounts of complex data from multiple domains becomes increasingly common, utilizing conventional correlation tools become ineffective for performing Insights as a Service Discovery (IaaSD), as the problem becomes a highly complex combinatorial multiobjective optimization problem that may take weeks for conventional correlation tools to properly process.

Accordingly, a method, computer system, and computer program product for improved insight discovery using combinatorial low-dimensional clustering would be advantageous. The method, system, and computer program product may detect a set of data point key performance indicators (KPIs) from one or more statistical or machine learning domain spaces. The method, system, computer program product may generate clusters including a series of binary vectors corresponding to the detected set of data point KPIs, wherein neighboring binary vectors having a mutual Mahalanobis distance below a threshold value are clustered together. The method, system, computer program product may then generating weighted binary matrix representations of the generated clusters. Thereafter, the method, system, computer program product may perform insight discovery by identifying data point intersections within the generated weighted binary matrix representations. In turn, the method, system, computer program product has provided for improved insight discovery using combinatorial low-dimensional clustering by leveraging combinatorial cluster strategies in which clusters, rather than individual binary vectors, are assigned binary matrix representations. Thus, the identify of each data point KPI in presently described embodiments is ciphered within the clustering pattern rather than by its association with a particular binary vector sequence. Deciphering the pattern allows the trajectory of an original data point KPI to be inferred with high confidence. Consequently, this learning results in significant reduction in KPI insight discovery time (down to the scale of hours rather than weeks when compared to conventional correlation analysis tools) for new data points. Furthermore, neighboring binary vectors of multiple statistical or machine learning domain spaces that also share the same initial search space are likely to exhibit similar data point trajectories. Hence, the similarity measure of clustering algorithm utilized by presently described embodiments may be based on the Mahalanobis distance of binary vectors and the initial search space of the binary vectors.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

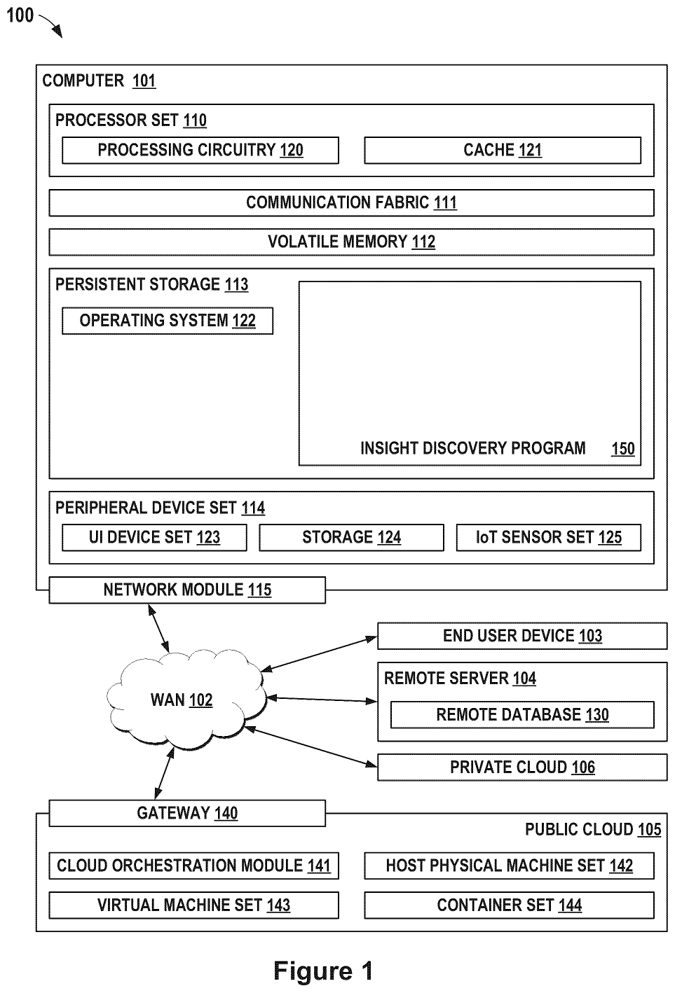

Referring now to FIG. 1, computing environment 100 contains an example of an environment for the execution of at least some of the computer code involved in performing the inventive methods, such as insight discovery program/code 150. In addition to insight discovery code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and insight discovery code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in insight discovery code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in insight discovery program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the insight discovery program 150 may be a program capable of detecting a set of data point key performance indicators (KPIs) from one or more statistical or machine learning domain spaces. Insight discovery program 150 may then generate clusters including a series of binary vectors corresponding to the detected set of data point KPIs, wherein neighboring binary vectors having a mutual Mahalanobis distance below a threshold value are clustered together. Next, insight discovery program 150 may generate weighted binary matrix representations of the generated clusters. Thereafter, insight discovery program 150 may perform insight discovery by identifying data point intersections within the generated weighted binary matrix representations. In turn, insight discovery program 150 has provided for improved insight discovery using combinatorial low-dimensional clustering by leveraging combinatorial cluster strategies in which clusters, rather than individual binary vectors, are assigned binary matrix representations. Thus, the identify of each data point KPI in presently described embodiments is ciphered within the clustering pattern rather than by its association with a particular binary vector sequence. Deciphering the pattern allows the trajectory of an original data point KPI to be inferred with high confidence. Consequently, this learning results in significant reduction in KPI insight discovery time (down to the scale of hours rather than weeks when compared to conventional correlation analysis tools) for new data points. Furthermore, neighboring binary vectors of multiple statistical or machine learning domain spaces that also share the same initial search space are likely to exhibit similar data point trajectories. Hence, the similarity measure of clustering algorithm utilized by presently described embodiments may be based on the Mahalanobis distance of binary vectors and the initial search space of the binary vectors.

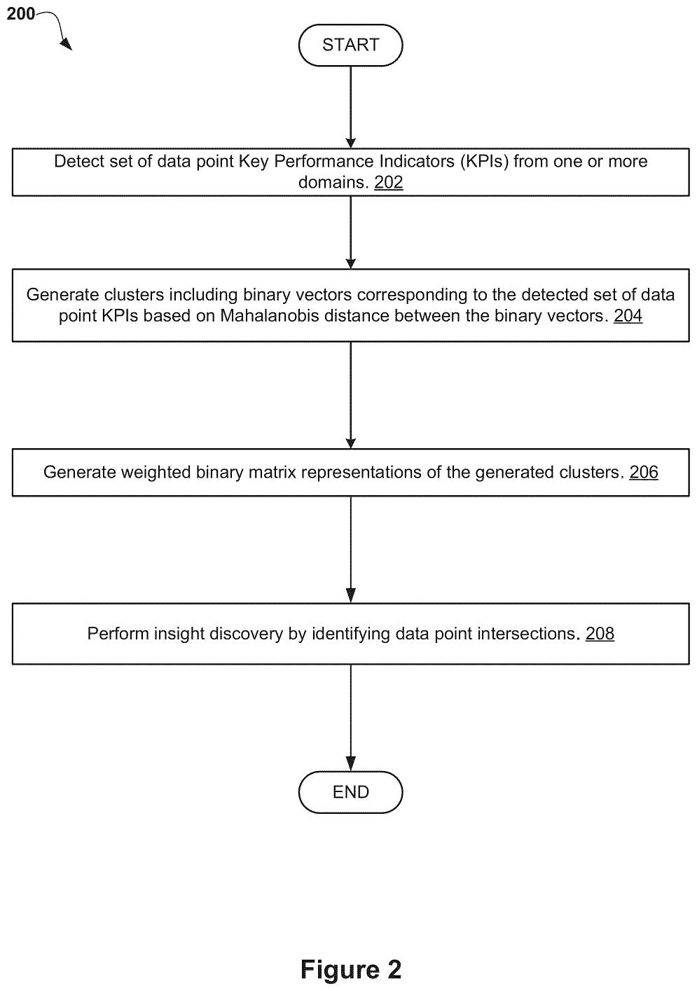

Referring now to FIG. 2, an operational flowchart for an illustrative process 200 of improved insight discovery using combinatorial low-dimensional clustering according to at least one embodiment is provided.

At 202, insight discovery program 150 may detecting a set of data point key performance indicators (KPIs) from one or more statistical or machine learning domain spaces. In embodiments, insight discovery program 150 may be a part of a correlation analysis tool integrated into any suitable Enterprise Performance Management (EPM) System. At this step, for example, insight discovery program 150 may be configured to detect any accessible sets of data point key performance indicators from one or more statistical or machine learning domain spaces. For example, in embodiments, insight discovery program 150 may be integrated or paired with an exemplary EPM system such that it may access any data collected by the EPM system, which may include, but is not limited to, data sourced from enterprise systems, databases, spreadsheets, and external sources. The detected set of data point key performance indicators may be derived from various statistical or machine learning domain spaces. For example, insight discovery program 150 may detect data point KPIs within finance business data spanning multiple business data domains such as sales, pricing, human resources, accounting, travel, support, etc.

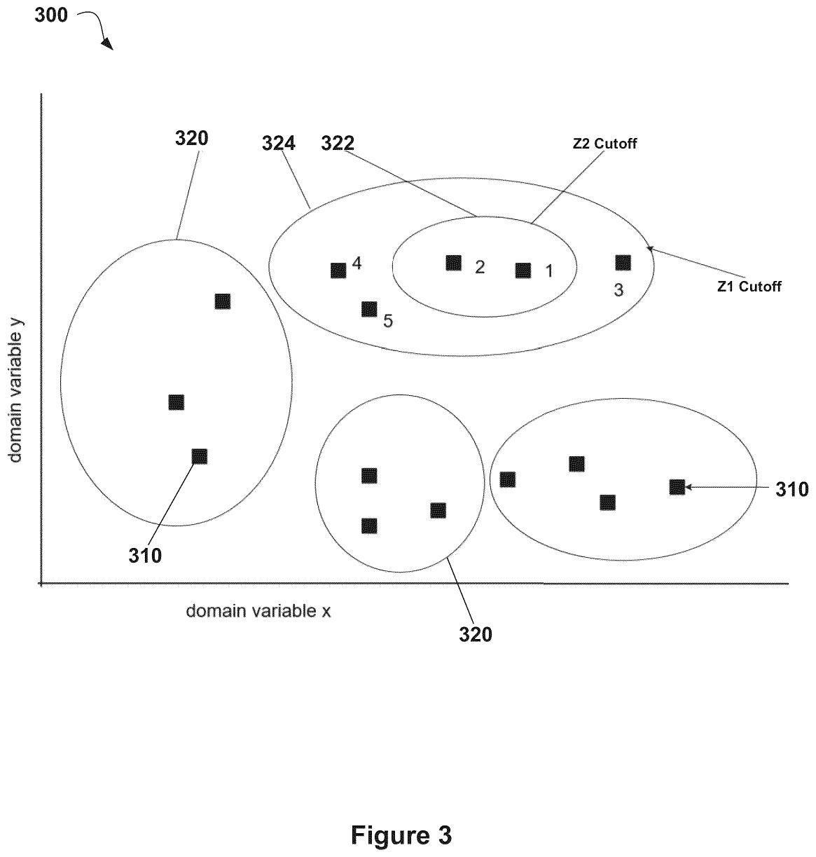

Next, at 204, insight discovery program 150 may generating clusters including a series of binary vectors corresponding to the detected set of data point KPIs, wherein neighboring binary vectors having a mutual Mahalanobis distance below a threshold value are clustered together. FIG. 3 depicts an illustrative clustering scheme 300 in accordance with step 204 including exemplary data point KPIs 310 and clusters 320. In FIG. 3, each of data point KPIs 310, represented as squares, are shown in differing statistical or machine learning domain search spaces of an exemplary clustering scheme 300, with domain variables x and y, denoting a target pattern (complex relationship insight in multivariate data) that may be activated by the binary vectors (data points KPI's). Data point KPI's ‘1’ and ‘2’ are shown to have a mutual Mahalanobis distance that is less than a predetermined cutoff threshold value (distance) of ‘z2’. Thus, insight discovery program 150 clusters data point KPIs ‘1’ and ‘2’ within the same cluster 322. In embodiments, insight discovery program 150 may be configured to adjust the cluster size by increasing the predetermined cutoff threshold value for Mahalanobis distance, thereby adjusting which data point KPIs would be close enough, or too far away, to share a cluster. As shown in FIG. 3, increasing the cluster cutoff threshold to z1 results in data point KPIs ‘3’, ‘4’, and ‘5’ becoming close enough to be clustered within a shared cluster 324. In embodiments, the detected data point KPIs may be encoded as binary vectors by insight discovery program 150 using any suitable encoding techniques.

For clarity, the Mahalanobis distance is utilized to measure how many standard deviations away each data point KPI is from the mean of the initial search space of the binary vector. Consequentially, binary vectors having a mutual Mahalanobis distance that is less than the cutoff threshold value are considered part of the same cluster. As noted above, cluster size can be increased by increasing the threshold, however, large cluster size may include binary vectors that are not closely related, thus reducing the potential of trajectory match between cluster members. Neighboring binary vectors of multiple statistical or learning domain spaces that also share the same initial search space are likely to exhibit similar data point trajectories.

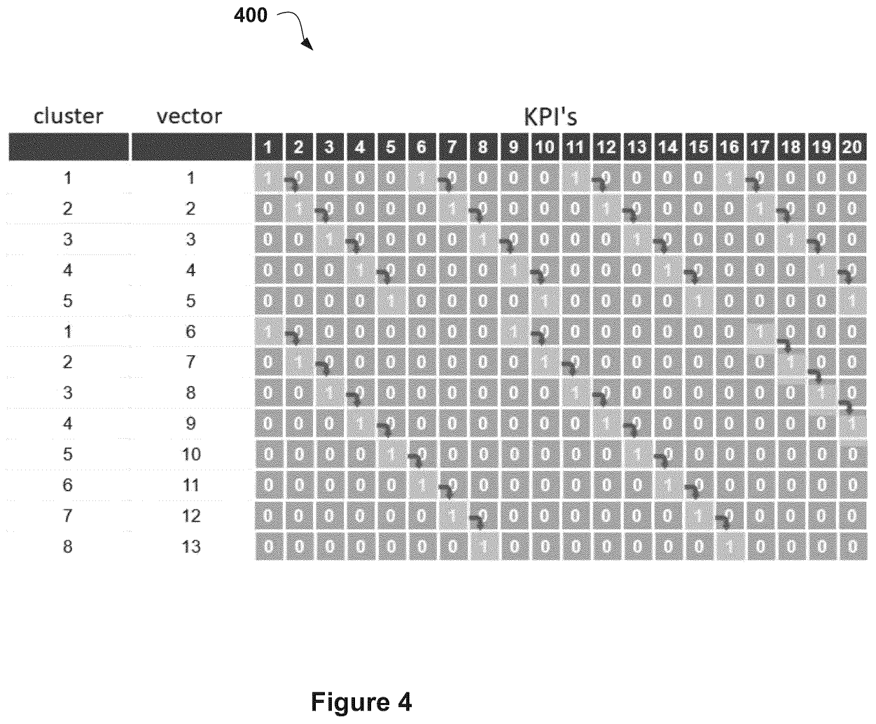

At 206, insight discovery program 150 may generate weighted binary matrix representations of the generated clusters from step 204. FIG. 4 illustrates an exemplary weighted binary matrix representation 400 of a clustering scheme including 20 exemplary binary vectors that may be generated by an illustrative insight discovery program 150. In embodiments, such as the example shown in FIG. 2, insight discovery program 150 may be configured to generate a weighted binary matrix representation for an exemplary clustering scheme including 20 binary vectors according to the following illustrative clustering scheme rules:

x=a1 (mod 5)

x=a2 (mod 8)

For each clustering rule, insight discovery program 150 may generate a cluster based on that rule. More generally, in embodiments, each clustering scheme rule may have the following linear congruence format:

x=a (mod n)

This format includes representations of the a, (a+n), (a+2n), . . . . KPI instances to the a'th cluster, where 0<a<=n, and where n is called the clustering scheme scope. In embodiments, insight discovery program 150 may be configured to let the clustering scheme group be a set of all clusters that are created according to a given n clustering scope. In general, an exemplary clustering scheme employed by an exemplary insight discovery program 150 may use a simultaneous linear congruence system of k clustering scheme rules as:

x=a1 (mod n1)

x=a2 (mod n2)

.

.

x=ak (mod nk)

As such, the total number of clusters ‘t’ in the clustering group may be given by:

$$t = n 1 + n 2 + … + n k$$

Specifically, and as per the example above, we can see that total number of clusters t may be given by the equation:

$$t = 5 + 8 = 13 .$$

This representation of the clustering scheme is exemplified in FIG. 2 by the binary matrix ‘M’ at 400. The entries of the matrix M at 400 are binary, either 0's or 1's. In embodiments, insight discovery program 150 may be configured to utilize suitable probabilistic data structures representing intra-positional sequence data point KPIs. Suitable probabilistic data structures that may be utilized by insight discovery program 150, may include, for example, bloom filters, cuckoo filters, HyperLogLog, Count-Min Sketch, or Trie. For example, in embodiments the rows of a generated matrix may represent binary vectors, and each row may be represented by a bloom filter, where columns represent data point KPI's. Thus, M is a matrix composed by t bloom filters. For example, if the first row is represented by the bloom filter 011001. . . , then it specifies that the 2nd, 3rd, 6th, . . . . KPI's together are included in binary vector number 1. As shown in FIG. 4, Matrix 400 includes 2 sets of clusters from 2 separate domains with clusters 1-5 from a first domain being associated with a first set of associated generated vectors 1-5, and clusters 1-8 from a second domain being associated with a second set of generated vectors 6-13.

In embodiments, an exemplary generated matrix generatable by an illustrative insight discovery program 150 at this step may have the following exemplary characteristics. In embodiments, bloom filters of an exemplary matrix may be partitioned to Y regions, such that a first domain search space has z1 bloom filters (rows), a second domain search space has z2 bloom filters, with the pattern repeating until the total number of applicable clusters is reached. In embodiments, in each domain search space, the first bloom filter may have a binary entry of ‘1’ in the first column. ‘1’ may then appear again after every increment that corresponds to the size of the corresponding clustering scheme scope. In embodiments, in the second bloom filter, the binary entry ‘1’ may start at the second column. This results in a ‘stairway pattern’ case in every domain search space (as shown in FIG. 4). In embodiments, insight discovery program 150 may include cluster scheme designs having a weight of ‘Y’, since every binary vector is executed only once in every clustering scheme scope. Hence, an exemplary binary matrix generated by insight discovery program 150 is weight balanced in that all data points KPI's are activated the same number of times. In addition, the total number of binary entries 1 in every domain search space of the matrix is the same. Thus, the sequencing capacity that is needed for each clustering scheme group is the same.

An impactful element in maximizing the efficiency of such a design is the choice of the clustering scope: n1, n2. . . , nk. Accordingly, in embodiments, an illustrative insight discovery program 150 may be configured to employ the Chinese Remainder Theorem (CRT) to maximize clustering scheme efficiency. The Chinese Remainder Theorem is a theorem which gives a unique solution to simultaneous linear congruences with coprime moduli. In its basic form, CRT will determine a number ‘p’ that, when divided by some given divisors, leaves given remainders. In embodiments, insight discovery program 150 may include clustering rules designed to satisfy two basic requirements. First, in embodiments, insight discovery program 150 may include a clustering rule ensuring that the size of every clustering scope chosen is greater than the square root of the number of binary vectors ‘k’. Second, in embodiments, insight discovery program 150 may include clustering rules ensuring that every set of clustering interval be designed, according to the CRT, to be coprime with respect to each other. This results in no clustering windows having a common factor other than 1. For instance, (5, 7, 9) are co-prime, but (9, 12) are not coprime because 3 is a common factor. These two requirements are denoted by the following equations:

n1; n2; . . . ; nk : n>=sqrRoot k

(ni; nj); i<>j: ni|nj

When these two conditions are applied. The CRT asserts that any two column vectors in the clustering matrix intersect, at most, one time. Thus, ‘Maximal intersection=1’ gives the minimal possible intersection for any clustering design of t<k and confers the highest likelihood of detecting the domain of each binary vector.

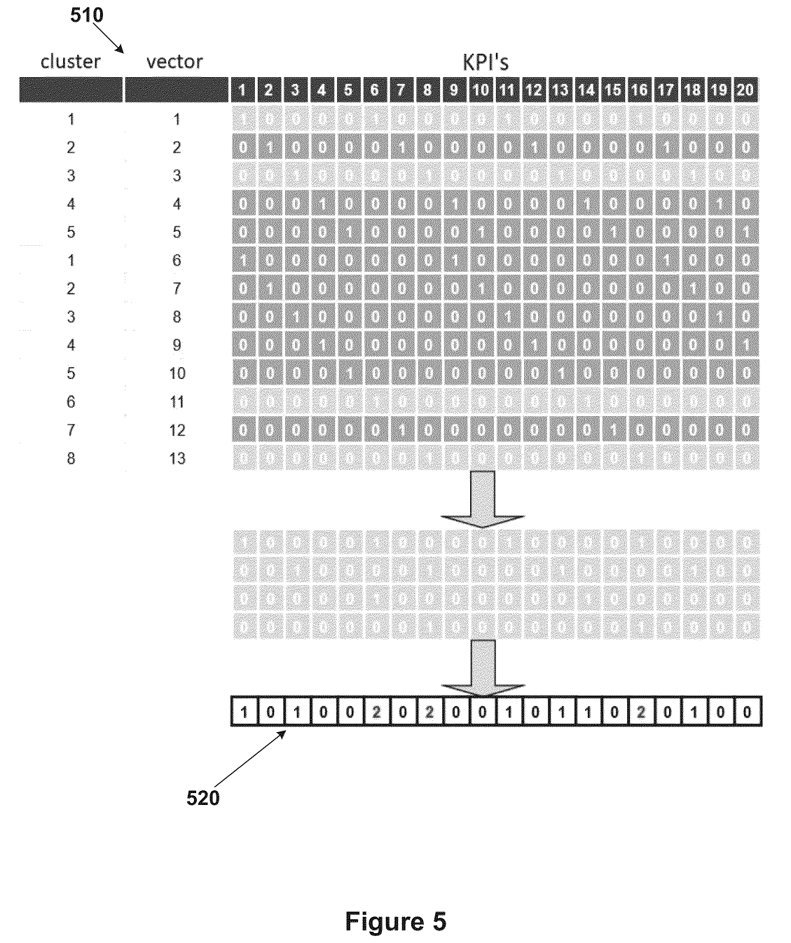

Thereafter, at 208, insight discovery program 150 perform insight discovery by identifying data point intersections within the generated weighted binary matrix representations. In other words, insight discovery program 150 may solve the clustering scheme by identifying which data patterns contain data point intersections. It may be noted that solving the clustering scheme is a discipline of learning which cluster pattern contain data point intersections (i.e., data points that grown towards same previous trajectories on multiple domain search spaces). FIG. 5 depicts two exemplary clustering windows at 510 and an associated illustrative histogram 520 that may be generated by an exemplary insight discovery program 150 by scanning the two exemplary clustering windows during an illustrative process for improved insight discovery using combinatorial low-dimensional clustering according to at least one embodiment. In the example shown in FIG. 5, the binary data to be deciphered may be represented using the following pattern: binary vector 1 associated with cluster 1 (from a first domain) and binary vector 11 associated with cluster 6 (from a second domain) each contain one or more data points in the same domain search space (new versus previously generated data points). The same may be observed with binary vector 3 associated with cluster 3 and binary vector 13 associated with cluster 8 (see highlighted rows at 510). To uncover the configuration that conduct to the observed pattern, insight discovery program 150 may utilize a decipher engine (not shown) to eliminate data points whose relationship with the intersect trajectory would break the observed pattern. In embodiments, for example, this is achieved by scanning a given clustering matrix representation along the binary vectors (rows) that contain a data point intersect trajectory and summing the columns of those rows, creating a histogram of data points versus the number of clusters in which it appeared. This represents the number of clustering windows in which a data point was found. This is shown in FIG. 5 at 510 which includes two clustering windows: 1) cluster 1 to 5 and 2) cluster 1 to 8. Insight discovery program 150 may then generate a histogram to identify data point intersections. In the example shown in FIG. 5, an associated histogram 530 may be generated by an illustrative insight discovery program 150. In histogram 530, it may be observed that the interval of scores of the histograms scale from 0 to the weight of the matrix. If a data point is an intersection, the domain search space should appear in all clustering windows harboring the data point. Thus, any data point with a level below the weight of the binary matrix in the histogram may be selected by insight discovery program 150. In the example shown in histogram 520 of FIG. 5, since data points 6, 8 and 16 have a score of 2 in the histogram, meaning it appeared in all possible clustering windows, they will be identified by an exemplary insight discovery program 150 as data point intersections, or in other words, valuable insight discovery from such inter-relationships. Histograms generated by illustrative insight discovery programs 150 essentially display the number of constraints fulfilled by associating the domain search space with each detected data point KPI. Thus, the above-described overall process represents clustering deciphering resulting in insights discovery.

It may be appreciated that insight discovery program 150 has thus provided improved insight discovery using combinatorial low-dimensional clustering by leveraging combinatorial cluster strategies in which clusters, rather than individual binary vectors, are assigned binary matrix representations. Thus, the identify of each data point KPI in presently described embodiments is ciphered within the clustering pattern rather than by its association with a particular binary vector sequence. Deciphering the pattern allows the trajectory of an original data point KPI to be inferred with high confidence. Consequently, this learning results in significant reduction in KPI insight discovery time (down to the scale of hours rather than weeks when compared to conventional correlation analysis tools) for new data points. Furthermore, neighboring binary vectors of multiple statistical or machine learning domain spaces that also share the same initial search space are likely to exhibit similar data point trajectories. Hence, the similarity measure of clustering algorithm utilized by presently described embodiments may be based on the Mahalanobis distance of binary vectors and the initial search space of the binary vectors.

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of performing automatic insight discovery across multiple statistical or machine learning domains, the method comprising:
detecting a set of data point key performance indicators (KPIs) from one or more statistical or machine learning domain spaces;
generating clusters including a series of binary vectors corresponding to the detected set of data point KPIs, wherein neighboring binary vectors having a mutual Mahalanobis distance below a threshold value are clustered together;
generating weighted binary matrix representations of the generated clusters; and
performing insight discovery by identifying data point intersections within the generated weighted binary matrix representations.

2. The computer-based method of claim 1, wherein generating the weighted binary matrix representations of the generated clusters further comprises:
applying a set of clustering rules following simultaneous linear congruence formats.

3. The computer-based method of claim 2, wherein generating the weighted binary matrix representations of the generated clusters further comprises:
utilizing probabilistic data structures representing intra-positional sequence data point KPIs.

4. The computer-based method of claim 3, wherein generating the weighted binary matrix representations of the generated clusters further comprises:
maximizing efficiency of the generated cluster schemes by employing a Chinese Remainder Theorem such that each set of clustering intervals is coprime with respect to each other.

5. The computer-based method of claim 1, wherein performing the insight discovery by identifying the data point intersections within the generated weighted binary matrix representations further comprises:
generating a histogram by summing columns within the generated weighted binary matrix representations of the generated clusters.

6. The computer-based method of claim 1, wherein the detected set of data point key performance indicators from the one or more statistical or machine learning domain spaces are stored within an accessible enterprise performance management system.

7. The computer-based method of claim 1, wherein the threshold value is adjustable to alter the size of the generated clusters.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
detecting a set of data point key performance indicators (KPIs) from one or more statistical or machine learning domain spaces;
generating clusters including a series of binary vectors corresponding to the detected set of data point KPIs, wherein neighboring binary vectors having a mutual Mahalanobis distance below a threshold value are clustered together;
generating weighted binary matrix representations of the generated clusters; and
performing insight discovery by identifying data point intersections within the generated weighted binary matrix representations.

9. The computer system of claim 8, wherein generating the weighted binary matrix representations of the generated clusters further comprises:
applying a set of clustering rules following simultaneous linear congruence formats.

10. The computer system of claim 9, wherein generating the weighted binary matrix representations of the generated clusters further comprises:
utilizing probabilistic data structures representing intra-positional sequence data point KPIs.

11. The computer system of claim 10, wherein generating the weighted binary matrix representations of the generated clusters further comprises:
maximizing efficiency of the generated cluster schemes by employing a Chinese Remainder Theorem such that each set of clustering intervals is coprime with respect to each other.

12. The computer system of claim 8, wherein performing the insight discovery by identifying the data point intersections within the generated weighted binary matrix representations further comprises:
generating a histogram by summing columns within the generated weighted binary matrix representations of the generated clusters.

13. The computer system of claim 8, wherein the detected set of data point key performance indicators from the one or more statistical or machine learning domain spaces are stored within an accessible enterprise performance management system.

14. The computer system of claim 8, wherein the threshold value is adjustable to alter the size of the generated clusters.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
detecting a set of data point key performance indicators (KPIs) from one or more statistical or machine learning domain spaces;
generating clusters including a series of binary vectors corresponding to the detected set of data point KPIs, wherein neighboring binary vectors having a mutual Mahalanobis distance below a threshold value are clustered together;
generating weighted binary matrix representations of the generated clusters; and
performing insight discovery by identifying data point intersections within the generated weighted binary matrix representations.

16. The computer program product of claim 15, wherein generating the weighted binary matrix representations of the generated clusters further comprises:
applying a set of clustering rules following simultaneous linear congruence formats.

17. The computer program product of claim 16, wherein generating the weighted binary matrix representations of the generated clusters further comprises:
utilizing probabilistic data structures representing intra-positional sequence data point KPIs.

18. The computer program product of claim 17, wherein generating the weighted binary matrix representations of the generated clusters further comprises:
maximizing efficiency of the generated cluster schemes by employing a Chinese Remainder Theorem such that each set of clustering intervals is coprime with respect to each other.

19. The computer program product of claim 15, wherein performing the insight discovery by identifying the data point intersections within the generated weighted binary matrix representations further comprises:
generating a histogram by summing columns within the generated weighted binary matrix representations of the generated clusters.

20. The computer program product of claim 15, wherein the detected set of data point key performance indicators from the one or more statistical or machine learning domain spaces are stored within an accessible enterprise performance management system.
